(19) United States
(12) Patent Application Publication
(10) Pub. No.: US 2026/0118195 A1
(43) Pub. Date: Apr. 30, 2026

(54) METHOD FOR GLASS-BONDING SEMICONDUCTOR CHIP, METHOD FOR MANUFACTURING PRESSURE SENSOR, AND BONDING APPARATUS

(71) Applicant: Kuwana Metals, Ltd., Kuwana-shi (JP)

(72) Inventor: Takahiro Umeyama, Mie-gun (JP)

(73) Assignee: Kuwana Metals, Ltd., Kuwana-shi (JP)

(21) Appl. No.: 19/108,456

(22) PCT Filed: Jul. 25, 2023
(86) PCT No.: PCT/JP2023/027177

§ 371 Date: Mar. 4, 2025

(30) Foreign Application Priority Data
Sep. 7, 2022 (JP) 2022-142595

(51) Int. Cl. G01L 9/00

(52) U.S. Cl. CPC G01L 9/0042

(57) ABSTRACT

A method which can achieve both more reliable glass-bonding and prevention of damage of a semiconductor chip due to heating and a bonding apparatus which can implement the method are disclosed. When a semiconductor chip is glass-bonded to an object to be bonded, the semiconductor chip is heated by a chip heater while the temperature of the chip heater is controlled at a temperature lower than the heat resistant temperature of the semiconductor chip, and the object to be bonded is heated by a substrate heater while the temperature of the substrate heater is controlled at a temperature higher than the temperature of the chip heater and the softening point of the low melting point glass.

### FIELD

The present invention relates to a method for glass-bonding a semiconductor chip, a method for manufacturing a pressure sensor, and a bonding apparatus.

### BACKGROUND

A pressure sensor of a type that uses a strain sensor comprising a semiconductor chip to measure strain of a diaphragm which deforms in response to changes in fluid pressure has been known. Pressure sensors are required to measure pressure of various types of fluids such as corrosive gases. For this reason, among parts constituting a pressure sensor, parts including a diaphragm which come into direct contact with the fluid are often formed of a material, such as stainless steel, having excellent corrosion resistance. In this case, when a difference in thermal expansion coefficient between the material constituting the strain sensor and the material constituting the diaphragm is large, there are problems that the strain sensor cannot be properly bonded to the diaphragm, or errors becomes more likely to occur in the measurements of the strain due to the generation of thermal stress in association with temperature changes.

To address the above problem, for example, in Japanese Patent Application Laid-Open (kokai) No. 2017-211338 (“PTL1”), an invention of a pressure sensor which can suppress the occurrence of thermal stress by having a bonding layer in a multilayer structure comprising three materials having different coefficients of thermal expansion when bonding a strain detection element comprising a semiconductor chip and a base using the bonding layer comprising low melting point glass is described. Moreover, for example, in International Patent Application Laid-Open No. 2016/056555 (“PTL2”) filed by the present applicant, an invention of a pressure sensor which can suppress the occurrence of thermal stress by bonding a strain sensor to a beam interlocked with a diaphragm and constituted by a material having a coefficient of thermal expansion close to that of the strain sensor is described.

Furthermore, a bonding apparatus which can perform solder-bonding by heating a workpiece for a short period of time while pressurizing the workpiece toward the substrate is known. For example, in Japanese Patent Application Laid-Open (kokai) No. H11-54904 (“PTL3”), an invention of a bonding apparatus which can perform solder-bonding in a short period of time by sending a phase-controlled pulsed large electric current through a heater while monitoring the temperature of the heater which pressurizes a workpiece using a temperature sensor is described.

### SUMMARY

According to an aspect, a method for glass-bonding a semiconductor chip, comprises a first step in which a bonding layer comprising low melting point glass is disposed on a substrate surface to be bonded, which is a predetermined surface of an object to be bonded, a second step in which said object to be bonded is placed on a substrate heater such that a substrate surface to be heated, which is a surface opposite to said substrate surface to be bonded among surfaces of said object to be bonded comes into contact with a surface of said substrate heater, a third step in which said semiconductor chip is placed on a surface of said bonding layer, a fourth step in which a surface of a chip heater is brought into contact with a chip surface to be heated, which is a surface opposite to a chip surface to be bonded, which is a surface in contact with said bonding layer among surfaces of said semiconductor chip, a fifth step in which a sandwiched and compressed state that is a state where said semiconductor chip, said bonding layer and said object to be bonded are sandwiched and compressed by said chip heater and said substrate heater in a first direction that is a stacking direction of said semiconductor chip, said bonding layer and said object to be bonded is achieved, a sixth step in which said semiconductor chip is heated by said chip heater while controlling the temperature of said chip heater to a first temperature that is a predetermined temperature lower than a heat resistant temperature of said semiconductor chip, and said object to be bonded is heated by said substrate heater while controlling the temperature of said substrate heater to a second temperature that is a predetermined temperature higher than the temperature of said chip heater and a softening point of said low melting point glass, in said sandwiched and compressed state, a seventh step in which said low melting point glass constituting said bonding layer is cooled by lowering the temperature of said chip heater and the temperature of said substrate heater while maintaining said sandwiched and compressed state, and an eighth step in which said sandwiched and compressed state is released and a bonded body constituted by said semiconductor chip glass-bonded to said object to be bonded is taken out. The size and shape of the part of the surface which comes into contact with said chip surface to be heated among the surfaces of said chip heater are provided so as to avoid a first region that is a predetermined region of said chip surface to be heated.

According to another aspect, a method for glass-bonding a semiconductor chip, includes a first step in which a bonding layer comprising low melting point glass is disposed on a substrate surface to be bonded, which is a predetermined surface of an object to be bonded, a second step in which said object to be bonded is placed on a substrate heater such that a substrate surface to be heated, which is a surface opposite to said substrate surface to be bonded among surfaces of said object to be bonded comes into contact with a surface of said substrate heater, a third step in which said semiconductor chip is placed on a surface of said bonding layer, a fourth step in which a surface of a chip heater is brought into contact with a chip surface to be heated, which is a surface opposite to a chip surface to be bonded, which is a surface in contact with said bonding layer among surfaces of said semiconductor chip, a fifth step in which a sandwiched and compressed state that is a state where said semiconductor chip, said bonding layer and said object to be bonded are sandwiched and compressed by said chip heater and said substrate heater in a first direction that is a stacking direction of said semiconductor chip, said bonding layer and said object to be bonded is achieved, a sixth step in which said semiconductor chip is heated by said chip heater while controlling the temperature of said chip heater to a first temperature that is a predetermined temperature lower than a heat resistant temperature of said semiconductor chip, and said object to be bonded is heated by said substrate heater while controlling the temperature of said substrate heater to a second temperature that is a predetermined temperature higher than the temperature of said chip heater and a softening point of said low melting point glass, in said sandwiched and compressed state, a seventh step in which said low melting point glass constituting said bonding layer is cooled by lowering the temperature of said chip heater and the temperature of said substrate heater while maintaining said sandwiched and compressed state, and an eighth step in which said sandwiched and compressed state is released and a bonded body constituted by said semiconductor chip glass-bonded to said object to be bonded is taken out. The object to be bonded has a thick part that is a part having a larger thickness than thicknesses of other parts, and said substrate heater further comprises an auxiliary heating means configured so as to come into contact with a surface of said object to be bonded, which is neither said substrate surface to be bonded nor said substrate surface to be heated in regard to said thick part.

According to yet another aspect, a bonding apparatus for glass-bonding a semiconductor chip to an object to be bonded, which has a bonding layer formed of low melting point glass disposed on a predetermined substrate surface to be bonded. The bonding apparatus comprises a chip heater which can adsorb and heat said semiconductor chip, a substrate heater on which said object to be bonded can be placed and heated, a temperature measurement means for individually measuring the temperatures of said chip heater and said substrate heater, a position adjustment means for accurately placing said semiconductor chip adsorbed by said chip heater at a position on a surface of said object to be bonded, on which said bonding layer is disposed, a pressurizing means for achieving a sandwiched and compressed state that is a state where said semiconductor chip, said bonding layer and said object to be bonded are sandwiched and compressed by said chip heater and said substrate heater in a stacking direction of said semiconductor chip, said bonding layer and said object to be bonded, a temperature control means for heating said semiconductor chip by said chip heater while controlling the temperature of said chip heater to a first temperature that is a predetermined temperature lower than a heat resistant temperature of said semiconductor chip, and heating said object to be bonded by said substrate heater while controlling the temperature of said substrate heater to a second temperature that is a predetermined temperature higher than the temperature of said chip heater and a softening point of said low melting point glass, in said sandwiched and compressed state, and thereafter cooling said low melting point glass constituting said bonding layer by lowering the temperature of said chip heater and the temperature of said substrate heater while maintaining said sandwiched and compressed state, and a taking-out means for releasing said sandwiched and compressed state and taking out a bonded body constituted by said semiconductor chip glass-bonded to said object to be bonded. The size and shape of the part of the surface which comes into contact with a chip surface to be heated, which is a surface opposite to a chip surface to be bonded, which is a surface in contact with said bonding layer among surfaces of said semiconductor chip, among the surfaces of said chip heater are provided so as to avoid a first region that is a predetermined region of said chip surface to be heated.

Yet another aspect may be characterized as A bonding apparatus for glass-bonding a semiconductor chip to an object to be bonded, which has a bonding layer formed of low melting point glass disposed on a predetermined substrate surface to be bonded. The bonding apparatus comprising a chip heater which can adsorb and heat said semiconductor chip, a substrate heater on which said object to be bonded can be placed and heated, a temperature measurement means for individually measuring the temperatures of said chip heater and said substrate heater, a position adjustment means for accurately placing said semiconductor chip adsorbed by said chip heater at a position on a surface of said object to be bonded, on which said bonding layer is disposed, a pressurizing means for achieving a sandwiched and compressed state that is a state where said semiconductor chip, said bonding layer and said object to be bonded are sandwiched and compressed by said chip heater and said substrate heater in a stacking direction of said semiconductor chip, said bonding layer and said object to be bonded, a temperature control means for heating said semiconductor chip by said chip heater while controlling the temperature of said chip heater to a first temperature that is a predetermined temperature lower than a heat resistant temperature of said semiconductor chip, and heating said object to be bonded by said substrate heater while controlling the temperature of said substrate heater to a second temperature that is a predetermined temperature higher than the temperature of said chip heater and a softening point of said low melting point glass, in said sandwiched and compressed state, and thereafter cooling said low melting point glass constituting said bonding layer by lowering the temperature of said chip heater and the temperature of said substrate heater while maintaining said sandwiched and compressed state, and a taking-out means for releasing said sandwiched and compressed state and taking out a bonded body constituted by said semiconductor chip glass-bonded to said object to be bonded. The object to be bonded has a thick part that is a part having a larger thickness than thicknesses of other parts, and said substrate heater further comprises an auxiliary heating means configured so as to come into contact with a surface of said object to be bonded, which is neither said substrate surface to be bonded nor a substrate surface to be heated, which is a surface opposite to said substrate surface to be bonded among surfaces of said object to be bonded, in regard to said thick part.

### BRIEF DESCRIPTION OF THE DRAWINGS

FIG. 1 is a flowchart for showing a method for glass-bonding a semiconductor chip according to the present invention.

FIG. 2 is a schematic cross-sectional view for showing changes in a positional relation among respective members in association with the progress of the method for glass-bonding a semiconductor chip according to the present invention.

FIG. 3 is a schematic cross-sectional view for showing an example of a bonding apparatus according to the present invention, which comprises a substrate heater constituted by a heat generating part and a heat adapter.

FIG. 4 is a schematic cross-sectional view for showing an example of an auxiliary heating means according to the present invention.

FIG. 5 is a schematic perspective view for showing an example of an auxiliary heating means according to the present invention.

FIG. 6 is a flowchart for showing a method of manufacturing a pressure sensor according to the present invention.

FIG. 7 is a schematic cross-sectional view for showing an example of a bonding apparatus according to the present invention.

FIG. 8 is a schematic diagram for showing an example of a shape of a chip heater according to the present invention.

FIG. 9 is a graph for showing an example of heating temperature profiles of heaters according to the present invention.

### DETAILED DESCRIPTION

### Technical Problem

In the pressure sensor described in the PTL1 reference, a bonding layer having a multilayer structure is used to bond the strain sensor and the diaphragm. For this reason, there are problems that it takes time and/or cost to form the bonding layer and the manufacturing process becomes complicated since multiple temperature settings are required for bonding. In the pressure sensor described in the PTL2 reference, there are problems that the temperature of the strain sensor tends to rise when the beam and the strain sensor are heated and bonded using solder or low melting point glass and therefore a bad influence may be exerted to the operation of the strain sensor.

It can be conceived to apply the heating mode in the bonding apparatus for performing solder-bonding (described in the PTL3 reference) to glass-bonding of a semiconductor chip that is the target of the present invention. However, since the softening point of glass is higher than the melting point of solder, the problem that softening the glass tends to cause the temperature rise of the strain sensor cannot be solved even when the heating time is shortened by sending a pulsed electric current through the heater.

The present invention has been made in view of the above problems, and one objective of the present invention is to provide a glass-bonding method in which the temperature of a bonding layer can be heated to a temperature higher than the softening point of glass and the temperature of a strain sensor in contact with the bonding layer can be prevented from exceeding the heat resistant temperature of the strain sensor when manufacturing a pressure sensor by glass-bonding, and a bonding apparatus which can carry out the method.

### Solution to Problem

In one embodiment, the present invention is a method for glass-bonding a semiconductor chip. The method can be implemented by sequentially performing the following steps.
S1: a first step in which a bonding layer comprising low melting point glass is disposed on a substrate surface to be bonded, which is a predetermined surface of an object to be bonded.
S2: a second step in which the object to be bonded is placed on a substrate heater such that a substrate surface to be heated, which is a surface opposite to the substrate surface to be bonded, among surfaces of the object to be bonded comes into contact with a surface of the substrate heater.
S3: a third step in which the semiconductor chip is placed on a surface of the bonding layer.
S4: a fourth step in which a surface of a chip heater is brought into contact with a chip surface to be heated, which is a surface opposite to a chip surface to be bonded, which is a surface in contact with the bonding layer, among surfaces of the semiconductor chip.
S5: a fifth step in which a sandwiched and compressed state that is a state where the semiconductor chip, the bonding layer and the object to be bonded are sandwiched and compressed by the chip heater and the substrate heater in a first direction that is a stacking direction of the semiconductor chip, the bonding layer and the object to be bonded is achieved.
S6: a sixth step in which the semiconductor chip is heated by the chip heater while controlling the temperature of the chip heater to a first temperature that is a predetermined temperature lower than a heat resistant temperature of the semiconductor chip, and the object to be bonded is heated by the substrate heater while controlling the temperature of the substrate heater to a second temperature that is a predetermined temperature higher than the temperature of the chip heater and a softening point of the low melting point glass, in the sandwiched and compressed state.
S7: a seventh step in which the low melting point glass constituting the bonding layer is cooled by lowering the temperature of the chip heater and the temperature of the substrate heater while maintaining the sandwiched and compressed state.
S8: an eighth step in which the sandwiched and compressed state is released and a bonded body constituted by the semiconductor chip glass-bonded to the object to be bonded is taken out.

By applying the method according to the present invention in which two types of heating means consisting of the chip heater and the substrate heater are used, the temperature of the bonding layer can be raised to a temperature higher than the softening point of the low melting point glass without causing the temperature of the semiconductor chip to exceed the heat resistant temperature.

In an embodiment, at least a part of the surface which comes into contact with the chip surface to be heated among the surfaces of the chip heater is formed of a material having a linear expansion coefficient which is one-half or more and not more than twice a linear expansion coefficient of the semiconductor chip. In this embodiment, since misalignment due to the difference in thermal expansion coefficient between the chip heater and the semiconductor chip hardly occurs in the pressurized bonding process, damage to the semiconductor chip is suppressed, and more reliable bonding can be achieved. In another embodiment, the present invention is an invention of a method for manufacturing a pressure sensor and an invention of a bonding

### Advantageous Effects of Invention

In accordance with the present invention, as compared with conventional glass-bonding methods in which a single heating means is used, a semiconductor chip can be more reliably bonded to an object to be bonded while avoiding damage to the semiconductor chip due to heat. Thereby, the manufacturing yield is improved and reliability of the pressure sensor is raised.

### Description of Embodiments

Embodiments for carrying out the present invention will be explained in detail below. The following explanation and drawings are exemplification of the embodiments for carrying out the present invention, and the embodiments for carrying out the present invention are not limited to the embodiments shown in the following explanation and drawings.

### First Embodiment

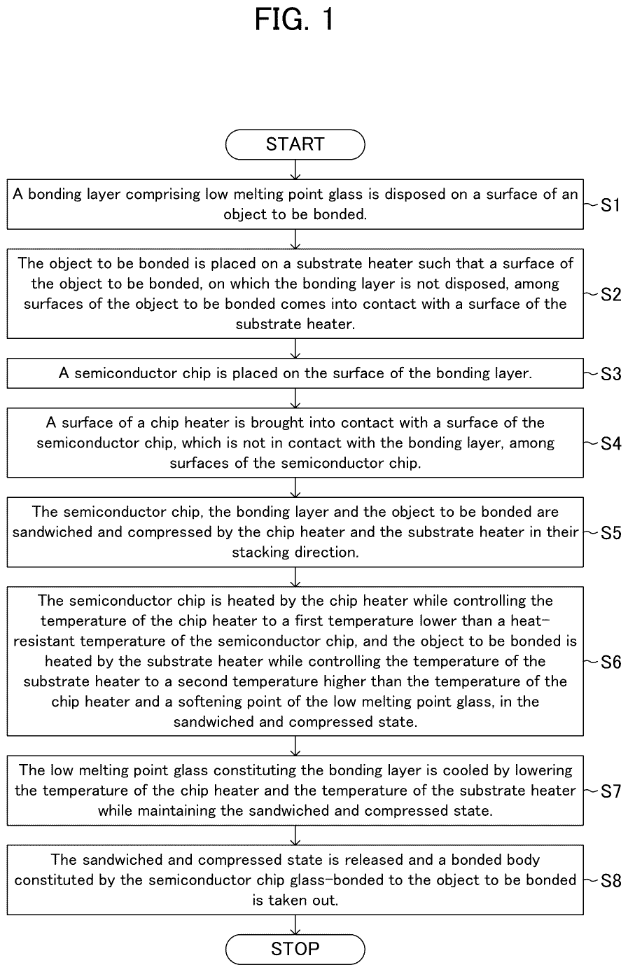

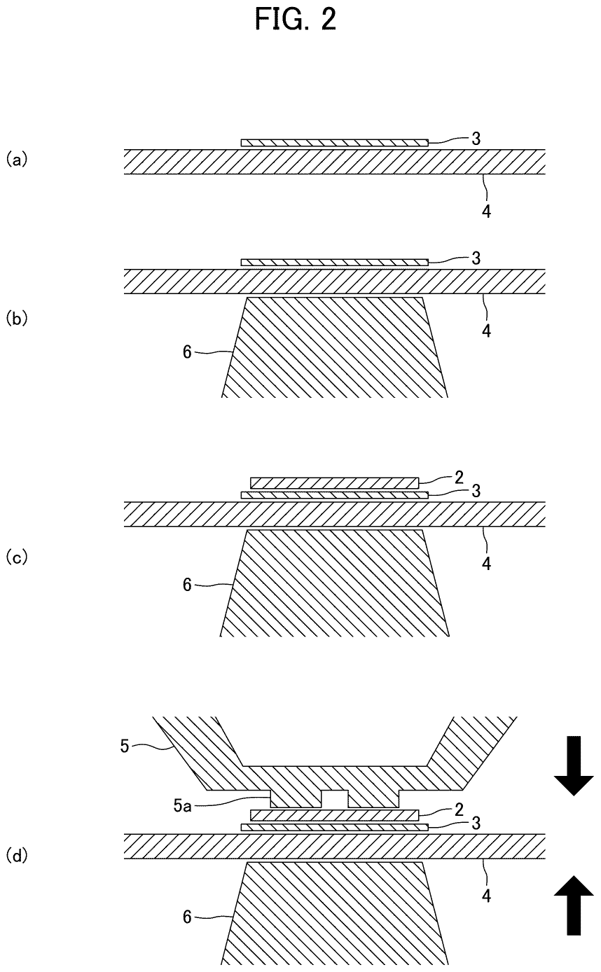

In a first embodiment, the present invention is an invention of a method for glass-bonding a semiconductor chip to an object to be bonded. FIG. 1 is a flowchart for showing the method. As shown in FIG. 1, the method includes eight steps from S1 to S8. Each step can be executed after the previous step has completed execution, unless otherwise specified. Therefore, these eight steps are preferably performed in principle according to the order described below. FIG. 2 is a schematic cross-sectional view for showing changes in a positional relation among respective members in association with the progress of the method for glass-bonding a semiconductor chip according to the present invention in accordance with the flowchart shown in FIG. 1.

The step S1 which is executed first is a step in which a bonding layer 3 comprising low melting point glass is disposed on a substrate surface to be bonded, which is a predetermined surface of an object 4 to be bonded (the upper surface in FIG. 2), as exemplified in FIG. 2(a). The object 4 to be bonded refers to a member to which a semiconductor chip is to be bonded using the method according to the present invention. As specific examples of the object 4 to be bonded, for example, a diaphragm constituting a pressure sensor, a beam interlocking with the diaphragm, or the like can be exemplified. The bonding layer 3 in the present invention is a layered adhesive disposed on the surface of the object 4 to be bonded, and is formed of low melting point glass. Since low melting point glass has higher insulating properties as compared with that of solder, it has the effect of preventing electrical noise from the object 4 to be bonded from being transmitted to the semiconductor chip. Additionally, low melting point glass has superior long-term bonding stability as compared with that of solder.

The low melting point glass constituting the bonding layer 3 in the present invention is a glass-based material developed primarily as a sealant or adhesive when assembling devices, and has a softening point of approximately 400° C. or lower. As examples of the low melting point glasses used in the present invention, low melting point glasses such as bismuth-based (main components: Bi2O3, ZnO), lead-based (main components: SiO2, B2O3, PbO), and vanadium-based (main components: TeO2, V2O5) can be exemplified, but the low melting point glasses are not limited to these. The bonding layer 3 in the present invention may be formed of only one type of low melting point glass, or may have a structure in which layers formed of two or more types of low melting point glass are stacked on each other.

The objective of providing the bonding layer 3 in the first step S1 is to interpose the bonding layer 3 between the semiconductor chip and the object 4 to be bonded and adhere them together. The position where the bonding layer 3 is disposed on the surface of the object 4 to be bonded, the shape of the bonding layer 3, and the thickness of the bonding layer 3 can be determined properly depending on the above-mentioned objective. As a specific means for providing the bonding layer 3, for example, a method in which a glass paste prepared by mixing the above-mentioned low melting point glass with an organic binder (also referred to as an “organic vehicle”) containing an organic solvent and a resin is disposed at a predetermined position on the object 4 to be bonded by screen printing can be adopted. By heating the object 4 to be bonded coated with the glass paste using this method to remove the organic solvent and baking it, the object 4 to be bonded having the bonding layer 3 formed of the low melting point glass disposed on its surface can be prepared.

The next second step S2 is a step in which the object 4 to be bonded is placed on a substrate heater 6 such that a surface opposite to the substrate surface to be bonded (the lower surface in FIG. 2, namely, a substrate surface to be heated) among surfaces of the object 4 to be bonded comes into contact with a surface of the substrate heater 6, as exemplified in (b) of FIG. 2. The substrate heater 6 is a heater used for the purpose of heating the object 4 to be bonded. The substrate heater 6 comprises a temperature sensor for measuring its own temperature, and can be raised to a predetermined temperature by a temperature control means (not shown). The “substrate” of the substrate heater 6 is a term given to an idea that the object 4 to be bonded, on which a semiconductor chip is mounted, is a kind of substrate.

The substrate heater 6 itself may be configured such that the surface of the substrate heater 6 which comes into contact with the object 4 to be bonded is along the substrate surface to be heated of the object 4 to be bonded and the object 4 to be bonded may be heated by bringing the substrate heater 6 into direct contact with the object 4 to be bonded. Alternatively, the substrate heater 6 may be constituted by a heat generating part that is a part comprising a heat generating part and a heat adapter that is a part interposed between the object 4 to be bonded and the heat generating part of the substrate heater 6 and the object 4 to be bonded may be heated by conducting heat from the heat generating part to the object 4 to be bonded through the heat adapter. In this case, the heat adapter may be configured such that the surface of the heat adapter, which comes into contact with the heat generating part, is along the shape of the heat generating part, and the heat adapter may be configured such that the surface of the heat adapter, which comes into contact with the object 4 to be bonded, is along the shape of the substrate surface to be heated. In accordance with such configurations, by replacing the heat adapter depending on the shape of the substrate surface to be heated, (the heat generating part of) one substrate heater can be used to heat a wide variety of objects 4 to be bonded.

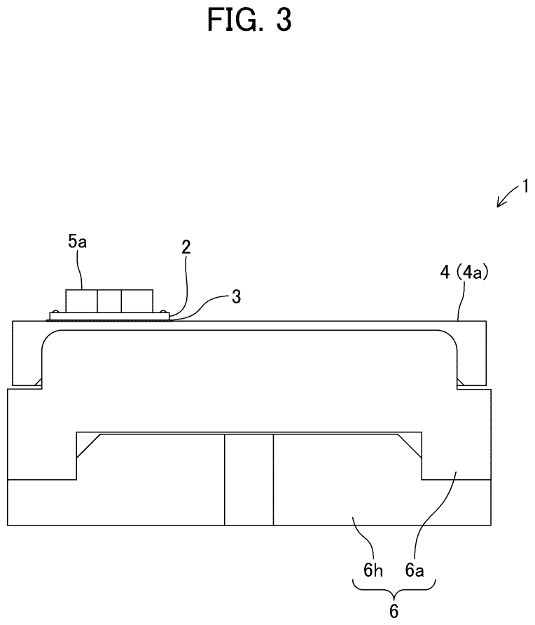

FIG. 3 is a schematic cross-sectional view for showing an example of a bonding apparatus according to the present invention, which comprises a substrate heater constituted by a heat generating part and a heat adapter as described above. In the bonding apparatus 1 exemplified in FIG. 3, a substrate heater 6 is constituted by a heat generating part 6h that is a part comprising a heating element (not shown) and a heat adapter 6a that is a part interposed between a beam 4a as the object 4 to be bonded and the heat generating part 6h. The surface of the heat adapter 6a, which comes into contact with the heat generating part 6h, is configured so as to be along the shape of the heat generating part 6h, and the surface of the heat adapter 6a, which comes into contact with the object 4 to be bonded, is configured so as to be along the shape of the substrate surface to be heated. As a result, the object 4 to be bonded can be heated by conducting heat from the heat generating part 6h to the object 4 to be bonded via the heat adapter 6a. Moreover, when heating the object 4 to be bonded, whose substrate surface to be heated has a different shape, by replacing the heat adapter 6a with another heat adapter 6a which matches the shape of the substrate surface to be heated of the object 4 to be bonded, the object 4 to be bonded can be heated without replacing the heat generating part 6h.

In the second step S2, when placing the object 4 to be bonded on the substrate heater 6, the substrate surface to be heated, which is the surface of the object 4 to be bonded on the opposite side of the substrate surface to be bonded among the surfaces of the object 4 to be bonded, namely the surface on which the bonding layer is not provided, is brought into contact with the surface of the substrate heater 6. By doing this, since the substrate surface to be heated comes into direct contact with the surface of the substrate heater 6, this is convenient for applying pressure from the substrate heater 6 to the object 4 to be bonded in the subsequent fifth step S5 and heating the object 4 to be bonded by the substrate heater 6 in the sixth step S6. Moreover, since the bonding layer 3 provided in the first step S1 appears on the surface of the object 4 to be bonded placed on the surface of the substrate heater 6, the semiconductor chip can be easily brought into contact with the surface of the bonding layer 3 in the subsequent third step S3. It is preferable that the bonding layer 3 is disposed on the upper surface of the object 4 to be bonded as exemplified in FIG. 2 since the semiconductor chip can be easily placed on the surface of the bonding layer 3. In the following explanation, a case where the bonding layer 3 is disposed on the upper surface of the object 4 to be bonded will be mentioned.

In the second step S2, as a specific means for placing the object 4 to be bonded on the substrate heater 6, a known method such as manual handling or handling using a robot arm can be adopted. The latter method is preferred in respect of positioning accuracy and/or production efficiency. It is more preferable that an imaging means such as a CCD camera is mounted on the robot arm and handling is performed while diagnosing the position and/or direction of the object 4 to be placed on the substrate heater based on the image.

The next third step S3 is a step in which a semiconductor chip 2 is placed on a surface of the bonding layer 3, as exemplified in (c) of FIG. 2. The objective of the third step S3 is to accurately place the semiconductor chip 2 in a correct orientation at a determined position on the surface of the bonding layer 3 disposed at the position where the semiconductor chip 2 is to be bonded in the first step S1. In the third step S3, the semiconductor chip 2 placed on the surface of the bonding layer 3 has not yet been glass-bonded to the object 4 to be bonded. Therefore, it is preferable to keep the surface of the bonding layer 3 horizontal, and to pay attention not to apply vibrations to the semiconductor chip 2, such that the position of the semiconductor chip 2 is not shifted.

In this specification, the term “semiconductor chip” refers to a semiconductor integrated circuit built into the surface of a substrate formed of a small piece of silicon (silicon substrate). It is preferable that the semiconductor chip 2 used in the present invention is a semiconductor chip which is referred to as what is called a bare chip. A bare chip is a semiconductor chip which does not comprise a package and has an exposed silicon substrate. Since bare chips lack a package, bare chips are directly affected by the surrounding environment. For this reason, when a sensor is constituted using a bare chip, the sensitivity of the sensor can be increased. On the other hand, since bare chips are easily affected by electrical noise, care needs to be taken to noise when using them.

As a specific means for handling the semiconductor chip 2 in the third step S3, a known method such as manual handling or handling using a robot arm can be adopted. The latter method is preferred in terms of positioning accuracy and/or production efficiency. More preferably, the robot arm is equipped with an imaging means such as a CCD camera, and the robot arm is handled while diagnosing the position and/or direction of the bonding layer on which the semiconductor chip is placed based on the image.

The next fourth step S4 is a step in which a surface of a tip part 5a of a chip heater 5 is brought into contact with a chip surface to be heated, which is a surface opposite to a chip surface to be bonded, which is a surface in contact with the bonding layer 3, among the surfaces of the semiconductor chip, as exemplified in (d) of FIG. 2. The chip heater 5 is a heater used for the purpose of heating the semiconductor chip 2, and is an independent heating means separate from the substrate heater 6. Similarly to the substrate heater 6, the chip heater 5 also comprises a temperature sensor for measuring its own temperature, and can be heated to a predetermined temperature by a temperature control means (not shown).

The chip heater 5 may be configured so as to have a function of vacuum adsorbing the semiconductor chip 2 and releasing the adsorption and to be able to drive the chip heater 5 by a robot arm. In this case, by performing the third step S3 in which the semiconductor chip 2 is vacuum adsorbed by the chip heater 5 comprising a robot arm and placed on the surface of the bonding layer 3, the fourth step S4 in which the surface of the chip heater 5 is brought into contact with the surface of the semiconductor chip 2 is also executed at the same time.

In the fourth step S4, the surface of the chip heater 5 is brought into contact with the chip surface to be heated, which is the surface opposite to the chip surface to be bonded, which is the surface in contact with the bonding layer 3, among the surfaces of the semiconductor chip 2. By doing this, since the chip surface to be heated comes into direct contact with the surface of the chip heater 5, this is convenient for applying pressure from the chip heater 5 to the semiconductor chip 2 in the subsequent fifth step S5 and heating the semiconductor chip 2 by the chip heater 5 in the sixth step S6.

The next fifth step S5 is a step in which a sandwiched and compressed state that is a state where the semiconductor chip 2, the bonding layer 3 and the object 4 to be bonded are sandwiched and compressed by the chip heater 5 and the substrate heater 6 in a first direction that is a stacking direction of the semiconductor chip 2, the bonding layer 3 and the object 4 to be bonded is achieved. In the fifth step S5, the entire structure in which the semiconductor chip 2, the bonding layer 3 and the object 4 to be bonded are stacked is sandwiched from both directions using the chip heater 5 and the substrate heater 6, and force is applied in the stacking direction of this structure (refer to the black arrow in (d) of FIG. 2). Specifically, a drive mechanism is provided in either one or both of the chip heater 5 and the substrate heater 6, and pressure is generated by driving them in a direction in which the both are brought closer together. As the drive mechanism, known means such as a foot pedal or an electric actuator can be adopted.

In the fifth step S5, pressure is applied in the direction in which the semiconductor chip 2, the bonding layer 3 and the object 4 to be bonded are stacked (stacking direction). In other words, compressive stress is applied to the structure in which the semiconductor chip 2, the bonding layer 3 and the object 4 to be bonded are stacked in a direction perpendicular to the stacked surface. At this time, transmission efficiency of the force is the best when respective members are arranged such that both of the surfaces of the chip heater 5 and substrate heater 6 which apply the stress are parallel to the stacked surface. On the other hand, when the surfaces of the chip heater 5 and the substrate heater 6 are inclined with respect to the stacked surface, for example, there is a possibility that the distance between the semiconductor chip 2 and the object 4 to be bonded may become uneven and the insulation between them may decrease to easily transmit the electrical noise from the object 4 to be bonded to the semiconductor chip 2, or there is a possibility that the semiconductor chip 2 may not be placed in the correct orientation with respect to the object 4 to be bonded and it may become difficult to demonstrate the performance of the semiconductor chip 2 (for example, performance as a strain gauge, or the like)

The objective of applying the pressure in the fifth step S5 is to form a strong bonding layer 3 by making softened low melting point glass flow while crushing the softened low melting point glass to bring the surfaces of the semiconductor chip 2 and the object 4 to be bonded in close contact without any gaps, when the low melting point glass constituting the bonding layer 3 is heated to a softening point or higher in the subsequent sixth step S6. When the pressure is too low, voids remain in the bonding layer 3 and the adhesive strength decreases. When the pressure is too high, the semiconductor chip 2 may be damaged and/or the bonding layer 3 may become too thin, resulting in insufficient electrical insulation between the semiconductor chip 2 and the object 4 to be bonded. A preferred range of the pressure is from 0.25 newton per square millimeter to 0.65 newton per square millimeter. In order to adjust the pressure, for example, energization means such as a spring can be provided in at least one of the drive mechanisms of the chip heater 5 and the substrate heater 6.

The next sixth step S6 is a step in which the semiconductor chip 2 is heated by the chip heater 5 while controlling the temperature of the chip heater 5 to a first temperature that is a predetermined temperature lower than a heat resistant temperature of the semiconductor chip 2, and the object 4 to be bonded is heated by the substrate heater 6 while controlling the temperature of the substrate heater 6 to a second temperature that is a predetermined temperature higher than the temperature of the chip heater 5 and a softening point of the low melting point glass, still in a state where the pressure is being applied, namely while maintaining the above-mentioned sandwiched and compressed state.

As mentioned above, the chip heater 5 and the substrate heater 6 comprise temperature sensors which individually measure their own temperatures, and can be heated to temperatures individually set by the temperature control means. When the method according to the present invention is repeatedly performed, the semiconductor chip 2 and the object 4 to be bonded, which are the targets to be heated by the chip heater 5 and the substrate heater 6, are replaced one after another. Therefore, it is difficult to measure temperatures of the semiconductor chip 2 and the object 4 to be bonded by temperature sensors provided to these members. For this reason, as an alternative means, the temperatures of the heaters themselves are measured. By investigating a correlation between the temperatures of the heater and the temperature of the target to be heated in advance, it is possible to estimate the temperature of the target to some extent.

In the sixth step S6, the semiconductor chip 2 is heated by the chip heater 5 while controlling the temperature of the chip heater 5 to a first temperature lower than the heat resistant temperature of the semiconductor chip 2. Although the heat resistant temperature of the semiconductor chip 2 varies somewhat depending on the type of the semiconductor chip 2, it is approximately higher than 400° C. and lower than 500° C. More precisely, it is 425° C. or higher and 475° C. or lower. Damage to the semiconductor chip 2 due to heating can be prevented by controlling the temperature of the chip heater 5 in direct contact with the surface of the semiconductor chip 2 to a first temperature lower than the heat resistant temperature of the semiconductor chip 2, for example, 400° C.

In the sixth step S6, the object 4 to be bonded is heated by the substrate heater 6 while controlling the temperature of the substrate heater 6 to a second temperature higher than the temperature of the chip heater 5 and the softening point of the low melting point glass. Although the softening point of low melting point glass varies somewhat depending on the type of low melting point glass, it is approximately higher than 400° C. and lower than 450° C. As mentioned above, the temperature of the chip heater 5 is controlled to a first temperature lower than the heat resistant temperature of the semiconductor chip 2, and the first temperature is often lower than the softening point of low melting point glass. Therefore, when the temperature of the substrate heater 6 is the same as the temperature of the chip heater 5, there is a possibility that the low melting point glass constituting the bonding layer 3 cannot be softened. Therefore, in the present invention, by controlling the temperature of the substrate heater 6 to a second temperature higher than the temperature of the chip heater 5 (namely, the first temperature) and the softening point of the low melting point glass, the low melting point glass is softened reliably and glass-bonding is realized. Such temperature control becomes possible for the first time by the method according to the present invention in which the temperatures of the chip heater 5 and the substrate heater 6 are controlled independently.

In principle, the sixth step S6 is executed in a state where the pressure is being applied, namely while maintaining the sandwiched and compressed state. This is because the heat of the heaters will not be efficiently transferred to the target unless pressure is applied from the chip heater 5 and the substrate heater 6 in advance to bring the surfaces of the heaters into close contact with the target, as described above. Moreover, this is because an ideal bonding layer 3 in which the low melting point glass is densely packed cannot be formed unless pressure is applied in advance when the low melting point glass starts to soften due to heating. Needless to say, glass-bonding according to the present invention is achieved by continuing the application of pressure during the heating step. However, it is acceptable in the present invention to start the pressurizing step (fifth step S5) and the heating step (sixth step S6) substantially at the same time, for example, for the purpose of increasing production efficiency, etc.

In the sixth step S6, it is preferable that the semiconductor chip 2 and the object 4 to be bonded are heated to the predetermined temperatures by the chip heater 5 and the substrate heater 6 respectively and thereafter these temperatures are maintained for a certain period of time. This is because it takes time for thermal diffusion before the temperature of the entire bonding layer reaches a temperature equal to the softening point or higher. The semiconductor chip 2 heated by the chip heater 5 and the object 4 to be bonded heated by the substrate heater 6 are adhered together by the bonding layer 3 having a thickness of approximately 30 micrometers. When the temperature of the substrate heater 6 (second temperature) is controlled and maintained at a temperature higher than the temperature of the chip heater 5 (first temperature), there is a possibility that heat may be transferred to the semiconductor chip 2 from the object 4 to be bonded heated to a high temperature through the thin bonding layer 3 and the temperature of the semiconductor chip 2 may exceed the heat resistant temperature. In order to prevent such problems, for example, it is effective to finish the sixth step S6 before the temperature of the semiconductor chip 2 reaches the heat resistant temperature due to the heat of the substrate heater 6 by adjusting the holding temperature (first temperature) of the chip heater 5 and the holding temperature (second temperature) of the substrate heater 6 and/or shortening the period of time for holding the temperatures.

The next seventh step S7 is a step in which the low melting point glass constituting the bonding layer 3 is cooled by lowering the temperature of the chip heater 5 and the temperature of the substrate heater 6 while maintaining the pressure, namely while maintaining the sandwiched and compressed state. When the bonding layer 3 formed of the low melting point glass is softened in the previous sixth step S6, the low melting point glass penetrates into the gap between the semiconductor chip 2 and the object 4 to be bonded due to the pressure, and forms the thin bonding layer 3. When the low melting point glass is cooled while maintaining this pressure in the seventh step S7, the bonding layer 3 changes to a hard glass state while remaining in close contact with the surfaces of the semiconductor chip 2 and the object 4 to be bonded, and a strong glass bond is realized.

When the speed at which the temperatures of the chip heater 5 and the substrate heater 6 are lowered in the seventh step S7 is too slow, the semiconductor chip 2 may be damaged by heat or the production efficiency may be reduced. On the other hand, when the speed is too high, cracks may occur in the bonding layer 3. A preferred range of cooling rate is 50° C./min or more and 150° C./min or less. The temperatures of the chip heater 5 and the substrate heater 6 may be lowered to room temperature at fixed cooling rates, the power supplies to the heaters may be turned off after reaching certain temperatures, or the temperatures may be held for fixed periods of time after reaching certain temperatures and thereafter the power supplies to the heaters may be turned off.

The next and final eighth step S8 is a step in which the pressure is released, namely the sandwiched and compressed state is released, and a bonded body constituted by the semiconductor chip 2 glass-bonded to the object 4 to be bonded is taken out. Since a strong bonding layer has already been formed in the previous seventh step S7, the adhesion between the semiconductor chip 2 and the object 4 to be bonded will not separate even when the pressure is released in the eighth step S8. In order to release the pressure, the above-mentioned drive mechanism may be operated to drive either one or both of the chip heater 5 and the substrate heater 6 in a direction away from each other. Moreover, in order to take out the bonded body, it is possible to adopt a means for moving the bonded body by vacuum adsorbing the surface of the semiconductor chip 2 using the robot arm explained in the second step S2.

By implementing the above-mentioned method according to the present invention, a semiconductor chip can be glass-bonded to an object to be bonded using a low melting point glass having a softening point higher than the heat resistant temperature of the semiconductor chip as a bonding layer. As shown in the sixth step S6, since the semiconductor chip is heated by the chip heater while controlling the temperature of the chip heater to be lower than the heat resistant temperature of the semiconductor chip, the temperature of the semiconductor chip never exceeds its heat resistant temperature. Moreover, since the object to be bonded is heated by the substrate heater while controlling the temperature of the substrate heater to be higher than the temperature of the chip heater and the softening point of the low melting point glass, the low melting point glass can be softened to complete the glass-bonding.

In a preferred embodiment of the present invention, at least a part of the surface which comes into contact with the chip surface to be heated among the surfaces of the chip heater is formed of a material having a linear expansion coefficient which is one-half or more and not more than twice a linear expansion coefficient of the semiconductor chip. In the method according to the present invention, the surface of the chip heater is brought into contact with the surface of the semiconductor chip, which is not in contact with the bonding layer, (namely, the chip surface to be heated) among the surfaces of the semiconductor chip (the fourth step S4), the pressure is applied by the chip heater and the substrate heater (the fifth step S5), and the semiconductor chip is heated by the chip heater and the object to be bonded is heated by the substrate heater (the sixth step S6). Moreover, the pressure is continued to be applied until the temperatures of the chip heater and the substrate heater are lowered to complete the glass-bonding (seventh step S7). When heating and cooling are performed in a state where the surface of the chip heater and the surface of the semiconductor chip are in close contact with each other under pressure in this way, the surface of the chip heater and the surface of the semiconductor chip may rub with each other due to the difference in the coefficient of thermal expansion between the materials constituting the surfaces of the surface of the chip heater and the surface of the semiconductor chip. When the pressure is high, this rubbing may cause scratches on the surface of the semiconductor chip to affect the operation of the semiconductor chip.

Therefore, in a preferred embodiment, at least a part of the surface which comes into contact with the chip surface to be heated among the surfaces of the chip heater is formed of a material having a linear expansion coefficient which is one-half or more and not more than twice a linear expansion coefficient of the semiconductor chip. In accordance with such a configuration, since the ratio of linear expansion coefficients of the materials forming the surfaces which rub with each other is one-half or more and not more than twice, the length of the scratches which occur due to the difference in thermal expansion coefficients can be limited and the risk of serious damage to the semiconductor chip can be reduced.

In a preferred embodiment of the present invention, the arithmetic mean roughness Ra of at least the surface of the chip heater which comes into contact with the chip surface to be heated is 0.80 micrometers or less. In this preferred embodiment, even if the chip heater and the semiconductor chip rubbed with each other due to a difference in coefficient of thermal expansion between the chip heater and the semiconductor chip, since the surface of the chip heater, which is the one of the surfaces rubbing against each other, is formed smoothly, the occurrence of scratches is suppressed. Thereby, the risk of serious damage to the semiconductor chip can be reduced.

In a preferred embodiment of the present invention, the bonding layer is disposed on the substrate surface to be bonded such that the semiconductor chip is included in the bonding layer in a projection view in the first direction that is the stacking direction of the semiconductor chip, the bonding layer and the object to be bonded. When the planar shape of the bonding layer formed of low melting point glass and disposed on the surface of the object to be bonded in the first step S1 is made to be the same shape as the projected surface of the semiconductor chip (namely, when the outline of the semiconductor chip overlaps with the outline of the bonding layer in the projection view in the first direction), there is a risk that the edge of the semiconductor chip may protrude from the bonding layer even a slight positional deviation occurs when placing the semiconductor chip on the surface of the bonding layer in the third step S3. In this case, since a part of the surface of the semiconductor chip to which the bonding layer is not in close contact occurs, strong glass-bonding cannot be realized. Moreover, even when the semiconductor chip is placed in the correct position in the third step S3, stress due to contraction in association with cooling of the low melting point glass in the seventh step S7 may concentrate on the corners of the semiconductor chip. In such a case, there is a risk that the bonding layer will peel off from the position where the stress is concentrated.

However, in the above-mentioned preferred embodiment, since the semiconductor chip is included in the bonding layer in the projection view in the first direction, the edge of the semiconductor chip never protrude from the bonding layer even if some positional deviation occurred when placing the semiconductor chip in the third step S3. Moreover, since the bonding layer is formed to the outside of the corners of the semiconductor chip, the stress concentration at the corners is alleviated. As a result of these effects, the semiconductor chip can be glass-bonded more reliably.

In a preferred embodiment of the present invention, the size and shape of the part of the surface which comes into contact with the chip surface to be heated among the surfaces of the chip heater are provided so as to avoid a first region that is a predetermined region of the chip surface to be heated. As specific examples of such a first region, for example, a region where bumps are disposed or a region where a member having a heat resistance temperature lower than the first temperature is disposed on the chip surface to be heated can be exemplified. Bumps on a semiconductor chip are structures which function as electrodes for exchanging electrical signals with the semiconductor chip, and are usually provided at plural positions on the periphery of the surface of the semiconductor chip. Since the bumps protrude from the surface of the semiconductor chip, when the surface of the chip heater is in contact with the bumps, the surface of the chip heater cannot be brought into close contact with the surface of the semiconductor chip (chip surface to be heated) in the fourth step S4 and the heating efficiency decreases. Additionally, there is a risk that the bumps will be damaged by the pressurization. Moreover, as a specific example of a member having a heat resistance temperature lower than the first temperature, a sensor element such as a strain gauge can be exemplified.

In the above-mentioned preferred embodiment, since the size and shape of the part of the surface which comes into contact with the chip surface to be heated among the surfaces of the chip heater are provided so as to avoid a first region that is a predetermined region of the chip surface to be heated, the above-mentioned problems can be solved.

By the way, objects to be bonded generally have a larger shape and a larger heat capacity than a semiconductor chip. Especially, when there is a part of the object to be bonded, which is thicker than other parts, the temperature of the part tends to be difficult to rise even when heated by the substrate heater. Even in a case where the object to be bonded is heated while controlling the temperature of the substrate heater to be a second temperature higher than the temperature of the chip heater (first temperature) and the softening point of the low melting point glass in the sixth step S6, when there is a part difficult to be heated, there is a risk that the temperature of the entire object to be bonded may not rise and, as a result, the temperature of the bonding layer may not exceed the softening point of the low melting point glass and glass-bonding may not be completed.

Therefore, in a preferred embodiment of the present invention, the object to be bonded has a thick part that is a part having a larger thickness than thicknesses of other parts, and the substrate heater further comprises an auxiliary heating means configured so as to come into contact with a surface of the object to be bonded, which is neither the substrate surface to be bonded nor the substrate surface to be heated in regard to the thick part. The auxiliary heating means can be realized, for example, by extending a part of the member constituting the substrate heater so as to sandwich or surround the thick part of the object to be bonded. Alternatively, the auxiliary heating means can be realized by adding a heating element around the thick part.

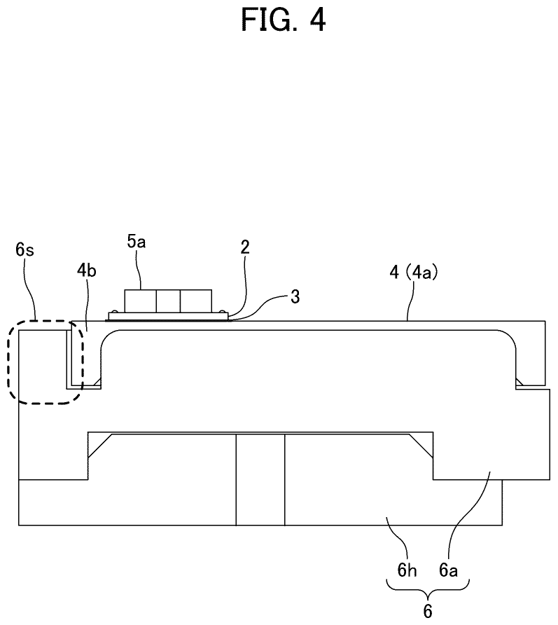

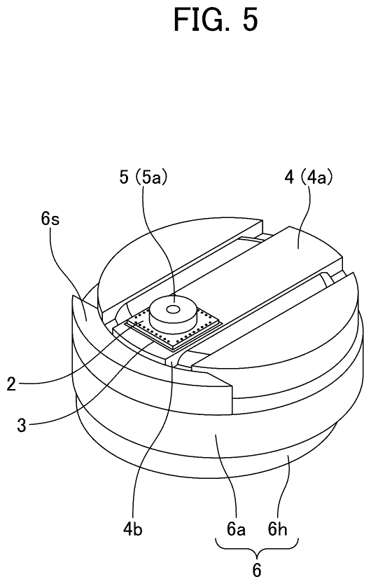

FIG. 4 is a schematic cross-sectional view for showing an example of the auxiliary heating means according to the present invention. Moreover, FIG. 5 is a schematic perspective view for showing an example of an auxiliary heating means according to the present invention. The beam 4a as the object 4 to be bonded exemplified in FIG. 4 and FIG. 5 has a thick part 4b which has larger thickness than those of other parts. Since the thick part 4b has a larger heat capacity than those of other parts, the thick part 4b is less likely to be heated than other parts. Therefore, as mentioned above, when only the substrate surface to be heated of the object 4 to be bonded is heated by the substrate heater 6, there is a possibility that the temperature of the entire object 4 to be bonded may not rise and, as a result, the temperature of the bonding layer 3 may not exceed the softening point of the low melting point glass and glass-bonding may not be completed.

Therefore, in this preferred embodiment, the substrate heater further comprises an auxiliary heating means configured so as to come into contact with a surface of the object to be bonded, which is neither the substrate surface to be bonded nor the substrate surface to be heated in regard to the thick part. The substrate heater 6 exemplified in FIG. 4 and FIG. 5 is constituted by the heat generating part 6h that is a part comprising a heating element and the heat adapter 6a that is a part interposed between the object 4 to be bonded and the heat generating part 6h, similarly to the substrate heater 6 exemplified in FIG. 3. However, in the substrate heater 6 exemplified in FIG. 4 and FIG. 5, as shown in the region 6s surrounded by a thick broken line in FIG. 4, a part of the heat adapter 6a is configured so as to surround and come into contact with the outer peripheral surface of the thick part 4b of the object 4 to be bonded. Thereby, the heating efficiency of the thick part 4b of the object 4 to be bonded is increased, and the above-mentioned problem can be solved. Namely, the region 6s surrounded by the thick broken line in FIG. 4 constitutes the auxiliary heating means.

### Second Embodiment

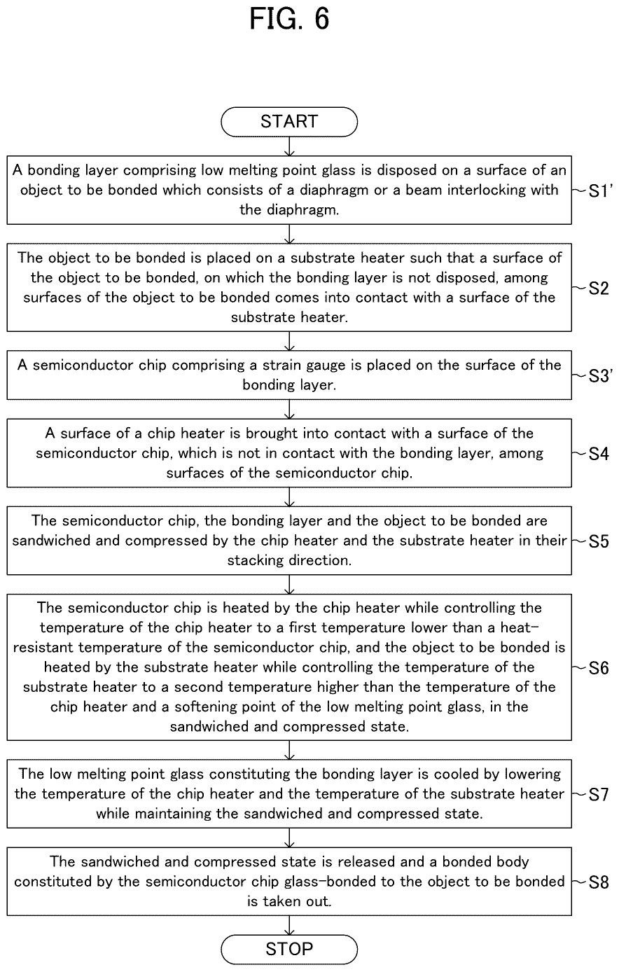

In a second embodiment, the present invention is a method for manufacturing a pressure sensor, including the method for glass-bonding a semiconductor chip according to the above-mentioned first embodiment of the present invention. However, in the second embodiment, the object to be bonded consists of a diaphragm which is deformed by pressure or a beam which interlocks with the diaphragm, and the semiconductor chip comprises a strain gauge. FIG. 6 is a flowchart for showing this method. As shown in FIG. 6, the method includes eight steps. The initial first step S1′ and the third step S3′ are steps specific to the method for manufacturing a pressure sensor. The remaining second step S2 and fourth step S4 to eighth step S8 are steps common to the method for glass-bonding semiconductor chips according to the first embodiment. In the following, the first step S1′ and the third step S3′, which are specific to the second embodiment, will be mainly explained.

The first step S1′ is a step in which a bonding layer comprising low melting point glass is disposed on a surface of an object to be bonded consisting of a diaphragm which is deformed by pressure or a beam interlocking with the diaphragm. The diaphragm in a pressure sensor is a thin plate-like member. In general, a diaphragm is made of corrosion-resistant stainless steel or the like, and its elastically deformable portion is configured in a shape of a flat disk, for example. One of the surfaces of the diaphragm defines a part of a closed space filled with fluid, and the other surface faces a vacuum or atmospheric pressure environment. The diaphragm itself has a restoring force, it elastically deforms to expand toward the vacuum or atmospheric pressure environment when the fluid pressure is high, and it returns to a flat shape when the fluid pressure returns to its original magnitude.

The beam interlocking with the diaphragm refers to a member which is formed of a material having a coefficient of thermal expansion close to that of a strain sensor comprising a semiconductor chip and is bonded to the diaphragm so as to follow the movement of the diaphragm which elastically deforms in response to changes in pressure, as seen in the pressure sensor described in the above-mentioned Patent Literature 2 (PTL2). When the strain sensor is not directly bonded to the diaphragm but is connected to a beam which interlocks with the diaphragm, since the diaphragm and the beam are separate members, a material with a coefficient of thermal expansion close to that of the strain sensor can be chosen as a material which constitutes the beam. As a result, since the thermal expansion coefficients of the strain sensor and the beam which is the object to be bonded can be brought to be close to each other, making it becomes possible to solve the problem caused by the difference in the coefficient of thermal expansion of the strain sensor and the object to be bonded. A joint between the diaphragm and the beam is constituted by welding, for example.

The objective of providing the bonding layer in the first step S1′ is to interpose the bonding layer between the semiconductor chip and the diaphragm or beam to bond them together, as in the case of the first step S1 in the first embodiment. The position where the bonding layer is disposed on the surface of the diaphragm or beam, the shape of the bonding layer and the thickness of the bonding layer can be properly determined depending on the above objective. As a specific means for providing the bonding layer, for example, a method in which a glass paste prepared by mixing the low melting point glass with an organic binder (also referred to as an “organic vehicle”) containing an organic solvent and a resin is disposed at a predetermined position on the diaphragm or beam by screen printing can be adopted, as in the case of the first step S1. By heating the diaphragm or beam coated with the glass paste using this method to remove the organic solvent and baking it, the diaphragm or beam having the bonding layer formed of the low melting point glass disposed on its surface can be prepared.

The third step S3′ is a step in which a semiconductor chip comprising a strain gauge is placed on the surface of the bonding layer. The objective of the third step S3′ is to accurately place the semiconductor chip comprising the strain gauge in a correct orientation at a determined position on the surface of the bonding layer disposed on the surface of the diaphragm or beam in the first step S1′. In order to manufacture a pressure sensor in the second embodiment, the semiconductor chip placed on the surface of the bonding layer must be a semiconductor chip comprising a strain gauge. By bonding such a semiconductor chip to the surface of the diaphragm or a beam, the strain of the diaphragm or the beam interlocking with the diaphragm can be measured to determine the pressure of fluid acting on the diaphragm.

In the present specification, a “strain gauge” refers to a sensor which measures strain of an object. As the strain gauge in the second embodiment, known strain gauges such as a metal strain gauge which utilizes changes in electrical resistance of metal foil or a semiconductor strain gauge which utilizes piezoresistance effect of a semiconductor can be used. Such strain gauges can be incorporated as a part of a semiconductor integrated circuit in a process of manufacturing semiconductor chips. In the semiconductor chip comprising a strain gauge, an amplifier circuit, a control circuit and/or a temperature sensor, etc. can be mounted in addition to the strain gauge.

Since the second step S2 and the steps from the fourth step S4 to the eighth step S8 after the third step S3′ are the same as the respective steps in the first embodiment, explanation thereof will be omitted here. However, in a case where the above-mentioned beam is used as the object to be bonded, if the diaphragm is bonded to the beam when performing the steps from the fourth step S4 to the eighth step S8, it may become difficult to apply pressure and/or heat to the beam. Therefore, in this case, it is preferable to implement the second embodiment using the beam before being bonded to the diaphragm. Note that the resultant product after completing all the steps included in the second embodiment, in which the semiconductor chip comprising the strain gauge is glass-bonded to the object to be bonded, is an intermediate product for manufacturing a pressure sensor, and therefore it is unfinished as a pressure sensor. A pressure sensor is completed by connecting a diaphragm and necessary peripheral equipment, such as a flexible printed wiring board and a power source, to this bonded body.

By carrying out the above-mentioned method according to the present invention, low melting point glass having a softening point higher than the heat resistant temperature of the semiconductor chip comprising a strain gauge can be used as the bonding layer to glass-bond the semiconductor chip to the diaphragm or the beam which interlocks with the diaphragm. Moreover, a finished product of a pressure sensor can be manufactured using the intermediate product obtained by this method. Since the bonding layer formed of low melting point glass has higher insulating properties than solder, for example, as mentioned above, unintended electrical noise is prevented from being transmitted to the semiconductor chip via the diaphragm or via the diaphragm and beam, and the reliability of the operation of the pressure sensor is increased. Furthermore, since low melting point glass has superior long-term stability of bonding as compared with solder, the life of the pressure sensor is extended.

In a preferred embodiment of the present invention, the size and shape of the part of the surface which comes into contact with the chip surface to be heated among the surfaces of the chip heater are provided so as to avoid a region where the strain gauge is disposed. In general, a strain gauge is often disposed in the center of a semiconductor chip. When the part of the surface of the chip heater, which comes into contact with the semiconductor chip overlaps the position where the strain gauge is provided, heat from the chip heater is easily transmitted to the strain gauge. In this case, there is a possibility that the temperature of the strain gauge may exceed the heat resistant temperature due to interaction with the heat transmitted from the substrate heater to the strain gauge via the object to be bonded.

In this preferred embodiment, since the surface of the chip heater is formed so as to avoid the region where the strain gauge is disposed, the heat from the chip heater is less likely to be transmitted to the strain gauge. For this reason, the strain gauge can be reliably prevented from being heated to a temperature exceeding the heat resistant temperature. As a specific shape of the surface of the chip heater, a doughnut-like shape having a hollow center part so as to avoid the strain gauge disposed in the center part of the semiconductor chip is preferred, for example.

### Third Embodiment

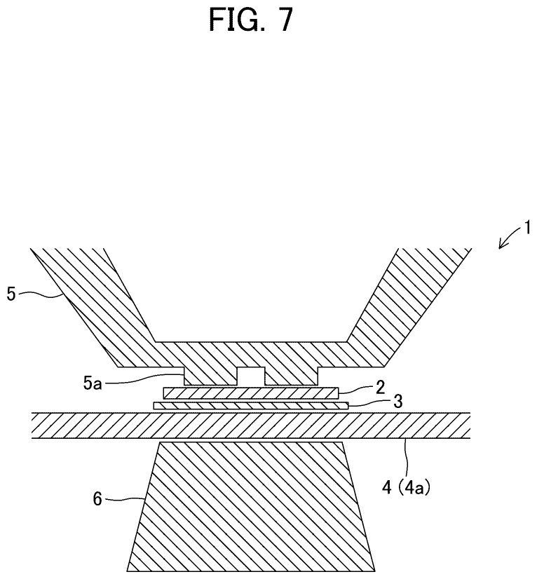

In a third embodiment, the present invention is a bonding apparatus for glass-bonding a semiconductor chip to an object to be bonded, which has a bonding layer made of low melting point glass disposed on a predetermined substrate surface to be bonded. As an overall structure, the bonding apparatus according to the present invention can have the same structure as that of the bonding apparatus which performs solder bonding described in the Patent Literature 3 (PTL3), for example. The bonding apparatus can be roughly divided into a part for performing glass-bonding and a power source for supplying a controlled electric current to heaters. FIG. 7 is a diagram for schematically showing only the main parts selected from the structure of the part where glass-bonding is performed. Hereinafter, the configuration of the bonding apparatus according to the present invention will be explained referring to FIG. 7.

The bonding apparatus 1 according to the present invention comprises a chip heater 5 which can adsorb and heat a semiconductor chip 2. The chip heater 5 has a function of adsorbing the semiconductor chip 2, a function of applying pressure to the semiconductor chip 2 and a function of heating the semiconductor chip 2. The chip heater 5 can adsorb the semiconductor chip 2, move the semiconductor chip 2 to a position where the bonding layer 3 is provided by a position adjustment means which will be mentioned later, and thereafter accurately place the semiconductor chip 2 at that position. The adsorption of the semiconductor chip 2 by the chip heater 5 can be realized by vacuum adsorption, for example. Specifically, for example, a cavity is formed in the tip part 5a of the chip heater 5, which comes into contact with the semiconductor chip 2, and the air existing in the cavity is evacuated by a vacuum pump, and thereby the semiconductor chip 2 can be adsorbed by vacuum to the chip heater 5. Moreover, by stopping the evacuation by the vacuum pump, the adsorption can be released and the semiconductor chip 2 can be separated from the chip heater 5. This cavity for adsorption may also serve as a cavity provided on the surface of the chip heater in order to avoid the first region that is a predetermined region of the chip heating surface as described above.

The chip heater 5 comprises a heating resistor and can heat the semiconductor chip 2 by supplying an electric current to the heating resistor. In the chip heater 5 exemplified in FIG. 7, the entire arms extending in the left and right directions is constituted by a heating resistor, and heat is generated by sending an electric current in the left-right direction. The tip part 5a to which the arms of the chip heater 5 are connected has a donut-like shape, and this tip part 5a comes into contact with the chip surface to be heated of the semiconductor chip 2 and transfers heat to the chip surface to be bonded.

The bonding apparatus 1 according to the present invention comprises a substrate heater 6 on which the object 4 to be bonded can be placed and heated. The substrate heater 6 is an independent heating mechanism separate from the chip heater 5. The object 4 to be bonded having the bonding layer 3 disposed on its surface is placed and heated on the substrate heater 6. The substrate heater 6 comprises a heating resistor and can heat the object 4 to be bonded by supplying an electric current to the heating resistor.

The bonding apparatus 1 according to the present invention comprises a temperature measurement means for individually measuring the temperatures of the chip heater 5 and the substrate heater 6. As the temperature measuring means, for example, a thermocouple or a resistance temperature detector, etc. can be used. By separately providing temperature measurement means for each of the chip heater 5 and the substrate heater 6, it becomes possible to control the temperatures of the chip heater 5 and the substrate heater 6 independently from each other using a temperature control means which will be mentioned later. In the chip heater 5 exemplified in FIG. 7, it is preferable to provide the temperature measuring means at a position close to the tip part 5a having a donut-shape, for example. Thereby, the temperature of the tip part 5a of the chip heater 5 heated by energization can be measured. Moreover, in the substrate heater 6 exemplified in FIG. 7, it is preferable to provide a temperature measuring means at a position close to the position where the object 4 to be bonded is placed, for example. Thereby, the temperature of the substrate heater 6 at the position closest to the object 4 to be bonded can be measured.

The bonding apparatus 1 according to the present invention comprises a position adjustment means (not shown) for accurately placing the semiconductor chip 2 adsorbed by the chip heater 5 at a position on a surface (substrate surface to be bonded) of the object 4 to be bonded, on which the bonding layer 3 is disposed. As a specific configuration of the position adjustment means, for example, it is preferable to adopt a robot arm as described above. The semiconductor chip 2 can be accurately placed at the position where the bonding layer 3 is provided by mounting an imaging means such as a CCD camera on the robot arm and diagnosing the position and/or direction of the bonding layer 3 based on the image.

The bonding apparatus 1 according to the present invention comprises a pressurizing means for achieving a sandwiched and compressed state that is a state where the semiconductor chip 2, the bonding layer 3 and the object 4 to be bonded are sandwiched and compressed by the chip heater 5 and the substrate heater 6 in a stacking direction of the semiconductor chip 2, the bonding layer 3 and the object 4 to be bonded. As a specific configuration of the pressurizing means, a drive mechanism is provided in either one or both of the chip heater 5 and the substrate heater 6, and pressure is applied by driving them in a direction in which the both are brought closer together, as mentioned above. As the drive mechanism, known means such as a foot pedal or an electric actuator can be adopted.

The bonding apparatus 1 according to the present invention comprises temperature control means which individually controls the temperatures of the chip heater 5 and the substrate heater 6. Namely, the temperature control means heats the semiconductor chip 2 by the chip heater 5 while controlling the temperature of the chip heater 5 so as to be a first temperature that is a predetermined temperature lower than the heat resistant temperature of the semiconductor chip 2. At the same time, the temperature control means heats the object 4 to be bonded by the substrate heater 6 while controlling the temperature of the substrate heater 6 so as to be a second temperature that is a predetermined temperature higher than the temperature of the chip heater 5 and the softening point of the low melting point glass. The temperatures of the chip heater 5 and the substrate heater 6 can be controlled independently from each other using the individually provided temperature measurement means.

It is preferable that the temperature control means holds the temperature of the chip heater 5 and the temperature of the substrate heater 6 respectively at constant temperatures after the above-mentioned heating is completed. As mentioned above, the low melting point glass softened during this time penetrates into the gap between the semiconductor chip 2 and the object 4 to be bonded due to the pressure, and forms the thin bonding layer 3. Next, the temperature control means cools the low melting point glass constituting the bonding layer 3 by lowering the temperature of the chip heater 5 and the temperature of the substrate heater 6 while holding the pressure. As mentioned above, during this time, the bonding layer 3 changes into a hard glass state while remaining in close contact with the surfaces of the semiconductor chip 2 and the object 4 to be bonded, and strong glass-bonding is completed.

The bonding apparatus 1 according to the present invention comprises a taking-out means for releasing the above-mentioned sandwiched and compressed state and taking out a bonded body constituted by the semiconductor chip 2 glass-bonded to the object 4 to be bonded. As mentioned above, since the strong bonding layer 3 has already been formed in the bonded body, the bond between the semiconductor chip 2 and the object 4 to be bonded will not separate even when the pressure is released. In order to release the pressure, the above-mentioned drive mechanism may be operated to drive either one or both of the chip heater 5 and the substrate heater 6 in a direction away from each other. Moreover, in order to take out the bonded body, a method such as using a robot arm to move the bonded body while vacuum adsorbing the surface of the semiconductor chip 2 and place it on a product storage area can be adopted, for example.

By using the above-mentioned bonding apparatus according to the present invention, it is possible to glass-bond a semiconductor chip to an object to be bonded using a low melting point glass having a softening point higher than the heat resistant temperature of the semiconductor chip for the bonding layer. Since the semiconductor chip is heated by the chip heater while controlling the temperature of the chip heater so as to become a first temperature lower than the heat resistant temperature of the semiconductor chip by the temperature control means, the temperature of the semiconductor chip never exceeds the heat resistant temperature. Moreover, since the object to be bonded is heated by the substrate heater while controlling the temperature of the substrate heater to a second temperature higher than the temperature of the chip heater and the softening point of the low melting point glass by the same temperature control means, the low melting point glass can be softened to complete glass-bonding.

### Working Example

Embodiments for carrying out the present invention will be explained in further detail using a working example. However, the working example explained here is merely an exemplification of an embodiment of the present invention, and embodiments of the present invention are not limited to the embodiment shown in this working example.

A beam 4a having the shape shown in FIG. 4 was fabricated by machining a workpiece made of Kovar (registered trademark) which is a compound obtained by mixing iron with nickel and cobalt. The diameter of the beam 4a was approximately 10 millimeters. The linear expansion coefficient of Kovar is 5.0×10⁻⁶/K. This value is close to the coefficient of thermal expansion of low melting point glass. Next, a bonding layer 3 made of low melting point glass is applied to the surface of the end part of the beam 4a by screen printing, and thereafter the beam 4a is heated to remove the organic solvent and the low melting point glass is baked. Thereby, a bonded object 4 consisting of the beam 4a with the bonding layer 3 formed of low melting point glass on its surface was prepared. The shape of the bonding layer 3 was a square with a length and width of 3.0 millimeters and a thickness of 30 micrometers to 40 micrometers. The length and width of this bonding layer 3 are larger than the length and width of 2.5 millimeters, which are the dimensions of a shape of the semiconductor chip 2 in a plane of projection.

Next, the beam 4a was placed as the object 4 to be bonded on the substrate heater 6 of the bonding apparatus 1 shown in FIG. 7. At this time, as shown in FIG. 4 and FIG. 5, the auxiliary heating means 6s was provided so as to come into contact with the outer peripheral surface of the thick part 4b of the beam 4a. Next, the semiconductor chip 2 comprising a strain gauge is adsorbed using the chip heater 5, and the semiconductor chip 2 was placed on the surface of the bonding layer 3 disposed on the beam 4a as the object 4 to be bonded using a position adjustment means (not shown) comprising a robot arm. The chip heater 5 which adsorbs the semiconductor chip 2 was made of tungsten carbide. The linear expansion coefficient of tungsten carbide is 5.6×10⁻⁶/K. This value is one-half or more and not more than twice of 3.0×10⁻⁶/K which is a linear expansion coefficient of silicon constituting the semiconductor chip. Moreover, among the surfaces of the tip part of the chip heater 5, the arithmetic mean roughness Ra of the surface which comes into contact with the surface of the semiconductor chip 2 (chip surface to be heated) is 0.80 micrometers.

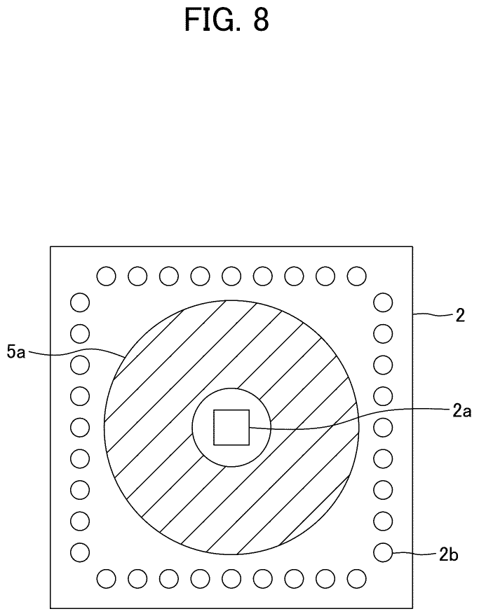

FIG. 8 is a schematic diagram for showing a positional relation between the surface of the semiconductor chip 2 on the side not in contact with the bonding layer 3 (chip surface to be heated) and the shape of the tip part 5a of the chip heater 5 which adsorbs this surface. A strain gauge 2a is present close to the center of the semiconductor chip 2. The tip part 5a of the chip heater 5 indicated by diagonal lines has a donut-like shape with a cavity formed in the center, and the region where the strain gauge 2a is provided can be avoided due to the cavity. Moreover, bumps 2b are present at the peripheral edge of the semiconductor chip 2. The size and shape of the tip part 5a of the chip heater 5 are configured so as to also avoid the area where the bumps 2b of the semiconductor chip 2 are provided.

Next, a drive mechanism (not shown) which interlocks with the chip heater 5 is operated to drive the chip heater 5 in the direction of the substrate heater 6, pressure is applied in the stacking direction of the semiconductor chip 2, the bonding layer 3 and the beam 4a, and sandwiched the chip 2, the bonding layer 3 and the beam 4a (the sandwiched and compressed state was achieved). The magnitude of the pressure in the bonding layer 3 at this time was 0.45 newtons per square millimeter. This magnitude of the pressure was adjusted by a spring provided at the joint between the drive mechanism and the chip heater 5.

Next, while maintaining the state where the pressure is applied as mentioned above (namely, the sandwiched and compressed state), the semiconductor chip 2 was heated by the chip heater 5 while controlling the temperature so as to be 400° C. lower than 450° C. which is the heat resistant temperature of the semiconductor chip 2, and the beam 4a and the auxiliary heating means 6a were heated by the substrate heater 6 while controlling the temperature of the substrate heater 6 so as to be 450° C. higher than 400° C. which is the temperature of the chip heater 5 and the temperature of the low melting point glass, using the temperature measuring means which the bonding apparatus 1 comprises. Namely, the first temperature was 400° C., and the second temperature was 450° C. The time required for this temperature rise was 60 seconds.

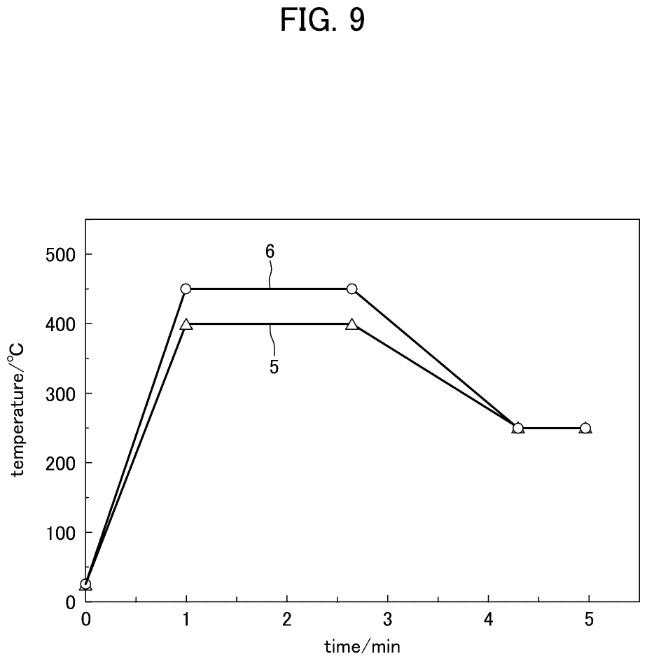

Next, heating was continued for 100 seconds while holding the temperature of the chip heater 5 at the first temperature of 400° C. and the temperature of the substrate heater 6 at the second temperature of 450° C., and thereafter the low melting point glass of the bonding layer 3 was cooled by lowering the temperature of the heater 5 and the temperature of the substrate heater 6 to 250° C. while holding the pressure. The time required for this temperature drop was 100 seconds. After the temperature was hold at 250° C. further for 40 seconds, the power supplies to the heaters were turned off. Time variation in the target temperatures of the chip heater 5 and the substrate heater 6 which the temperature control means attempted to control during this period is shown in FIG. 9.

Next, after the pressure was released (namely, the sandwiched and compressed state was released) and the bonded body in which the semiconductor chip 2 is glass-bonded to the beam 4a was vacuum-adsorbed by the chip heater 5, the bonded body was moved to the product storage area by the position adjustment means, the vacuum was released to place the bonded body there. The beam 4a of the obtained bonded body was welded to a diaphragm, and electrodes and other accessories were attached to complete a pressure sensor.

As a result of inspecting the pressure sensor manufactured by the above-mentioned method, the glass-bonding between the semiconductor chip 2 and the beam 4a was strong, and no peeling of the bond was observed. Moreover, the operation of the pressure sensor was stable, and no electrical noise was observed in its output signal.

1-11. (canceled)

12. A method for glass-bonding a semiconductor chip, including:
a first step in which a bonding layer comprising low melting point glass is disposed on a substrate surface to be bonded, which is a predetermined surface of an object to be bonded,
a second step in which said object to be bonded is placed on a substrate heater such that a substrate surface to be heated, which is a surface opposite to said substrate surface to be bonded among surfaces of said object to be bonded comes into contact with a surface of said substrate heater,
a third step in which said semiconductor chip is placed on a surface of said bonding layer,
a fourth step in which a surface of a chip heater is brought into contact with a chip surface to be heated, which is a surface opposite to a chip surface to be bonded, which is a surface in contact with said bonding layer among surfaces of said semiconductor chip,
a fifth step in which a sandwiched and compressed state that is a state where said semiconductor chip, said bonding layer and said object to be bonded are sandwiched and compressed by said chip heater and said substrate heater in a first direction that is a stacking direction of said semiconductor chip, said bonding layer and said object to be bonded is achieved,
a sixth step in which said semiconductor chip is heated by said chip heater while controlling the temperature of said chip heater to a first temperature that is a predetermined temperature lower than a heat resistant temperature of said semiconductor chip, and said object to be bonded is heated by said substrate heater while controlling the temperature of said substrate heater to a second temperature that is a predetermined temperature higher than the temperature of said chip heater and a softening point of said low melting point glass, in said sandwiched and compressed state, a seventh step in which said low melting point glass constituting said bonding layer is cooled by lowering the temperature of said chip heater and the temperature of said substrate heater while maintaining said sandwiched and compressed state, and
an eighth step in which said sandwiched and compressed state is released and a bonded body constituted by said semiconductor chip glass-bonded to said object to be bonded is taken out, and
the size and shape of the part of the surface which comes into contact with said chip surface to be heated among the surfaces of said chip heater are provided so as to avoid a first region that is a predetermined region of said chip surface to be heated.

13. The method for glass-bonding a semiconductor chip according to claim 12, wherein said first region of said semiconductor chip is a region where bumps are disposed or a region where a member having a heat resistance temperature lower than said first temperature is disposed.

14. The method for glass-bonding a semiconductor chip according to claim 12, wherein at least a part of the surface which comes into contact with said chip surface to be heated among the surfaces of said chip heater is formed of a material having a linear expansion coefficient which is one-half or more and not more than twice a linear expansion coefficient of said semiconductor chip.

15. The method for glass-bonding a semiconductor chip according to claim 12, wherein the arithmetic mean roughness Ra of at least the surface of the chip heater which comes into contact with said chip surface to be heated is 0.80 micrometers or less.

16. The method for glass-bonding a semiconductor chip according to claim 12, wherein said bonding layer is disposed on said substrate surface to be bonded such that said semiconductor chip is included in said bonding layer in a projection view in said first direction.

17. The method for glass-bonding a semiconductor chip according to claim 12, wherein:
said object to be bonded consists of a diaphragm which is deformed by pressure or a beam which interlocks with said diaphragm, and
said semiconductor chip comprises a strain gauge.

18. The method for glass-bonding a semiconductor chip according to claim 17, wherein:
said first region of said semiconductor chip is a region where said strain gauge is disposed.

19. A method for glass-bonding a semiconductor chip, including:
a first step in which a bonding layer comprising low melting point glass is disposed on a substrate surface to be bonded, which is a predetermined surface of an object to be bonded,
a second step in which said object to be bonded is placed on a substrate heater such that a substrate surface to be heated, which is a surface opposite to said substrate surface to be bonded among surfaces of said object to be bonded comes into contact with a surface of said substrate heater,
a third step in which said semiconductor chip is placed on a surface of said bonding layer,
a fourth step in which a surface of a chip heater is brought into contact with a chip surface to be heated, which is a surface opposite to a chip surface to be bonded, which is a surface in contact with said bonding layer among surfaces of said semiconductor chip,
a fifth step in which a sandwiched and compressed state that is a state where said semiconductor chip, said bonding layer and said object to be bonded are sandwiched and compressed by said chip heater and said substrate heater in a first direction that is a stacking direction of said semiconductor chip, said bonding layer and said object to be bonded is achieved,
a sixth step in which said semiconductor chip is heated by said chip heater while controlling the temperature of said chip heater to a first temperature that is a predetermined temperature lower than a heat resistant temperature of said semiconductor chip, and said object to be bonded is heated by said substrate heater while controlling the temperature of said substrate heater to a second temperature that is a predetermined temperature higher than the temperature of said chip heater and a softening point of said low melting point glass, in said sandwiched and compressed state,
a seventh step in which said low melting point glass constituting said bonding layer is cooled by lowering the temperature of said chip heater and the temperature of said substrate heater while maintaining said sandwiched and compressed state, and
an eighth step in which said sandwiched and compressed state is released and a bonded body constituted by said semiconductor chip glass-bonded to said object to be bonded is taken out, and
said object to be bonded has a thick part that is a part having a larger thickness than thicknesses of other parts, and
said substrate heater further comprises an auxiliary heating means configured so as to come into contact with a surface of said object to be bonded, which is neither said substrate surface to be bonded nor said substrate surface to be heated in regard to said thick part.

20. The method for glass-bonding a semiconductor chip according to claim 19, wherein at least a part of the surface which comes into contact with said chip surface to be heated among the surfaces of said chip heater is formed of a material having a linear expansion coefficient which is one-half or more and not more than twice a linear expansion coefficient of said semiconductor chip.

21. The method for glass-bonding a semiconductor chip according to claim 19, wherein the arithmetic mean roughness Ra of at least the surface of the chip heater which comes into contact with said chip surface to be heated is 0.80 micrometers or less.

22. The method for glass-bonding a semiconductor chip according to claim 19, wherein said bonding layer is disposed on said substrate surface to be bonded such that said semiconductor chip is included in said bonding layer in a projection view in said first direction.

23. glass-bonding a semiconductor chip according to claim 19, wherein:
said object to be bonded consists of a diaphragm which is deformed by pressure or a beam which interlocks with said diaphragm, and
said semiconductor chip comprises a strain gauge.

24. A bonding apparatus for glass-bonding a semiconductor chip to an object to be bonded, which has a bonding layer formed of low melting point glass disposed on a predetermined substrate surface to be bonded, comprising:
a chip heater which can adsorb and heat said semiconductor chip,
a substrate heater on which said object to be bonded can be placed and heated,
a temperature measurement means for individually measuring the temperatures of said chip heater and said substrate heater,
a position adjustment means for accurately placing said semiconductor chip adsorbed by said chip heater at a position on a surface of said object to be bonded, on which said bonding layer is disposed,
a pressurizing means for achieving a sandwiched and compressed state that is a state where said semiconductor chip, said bonding layer and said object to be bonded are sandwiched and compressed by said chip heater and said substrate heater in a stacking direction of said semiconductor chip, said bonding layer and said object to be bonded,
a temperature control means for heating said semiconductor chip by said chip heater while controlling the temperature of said chip heater to a first temperature that is a predetermined temperature lower than a heat resistant temperature of said semiconductor chip, and heating said object to be bonded by said substrate heater while controlling the temperature of said substrate heater to a second temperature that is a predetermined temperature higher than the temperature of said chip heater and a softening point of said low melting point glass, in said sandwiched and compressed state, and thereafter cooling said low melting point glass constituting said bonding layer by lowering the temperature of said chip heater and the temperature of said substrate heater while maintaining said sandwiched and compressed state, and
a taking-out means for releasing said sandwiched and compressed state and taking out a bonded body constituted by said semiconductor chip glass-bonded to said object to be bonded, and
the size and shape of the part of the surface which comes into contact with a chip surface to be heated, which is a surface opposite to a chip surface to be bonded, which is a surface in contact with said bonding layer among surfaces of said semiconductor chip, among the surfaces of said chip heater are provided so as to avoid a first region that is a predetermined region of said chip surface to be heated.

25. The bonding apparatus for glass-bonding a semiconductor chip to an object to be bonded according to claim 24, wherein:
said first region of said semiconductor chip is a region where bumps are disposed or a region where a member having a heat resistance temperature lower than said first temperature is disposed.

26. A bonding apparatus for glass-bonding a semiconductor chip to an object to be bonded, which has a bonding layer formed of low melting point glass disposed on a predetermined substrate surface to be bonded, comprising:
a chip heater which can adsorb and heat said semiconductor chip,
a substrate heater on which said object to be bonded can be placed and heated,
a temperature measurement means for individually measuring the temperatures of said chip heater and said substrate heater,
a position adjustment means for accurately placing said semiconductor chip adsorbed by said chip heater at a position on a surface of said object to be bonded, on which said bonding layer is disposed, a pressurizing means for achieving a sandwiched and compressed state that is a state where said semiconductor chip, said bonding layer and said object to be bonded are sandwiched and compressed by said chip heater and said substrate heater in a stacking direction of said semiconductor chip, said bonding layer and said object to be bonded,
a temperature control means for heating said semiconductor chip by said chip heater while controlling the temperature of said chip heater to a first temperature that is a predetermined temperature lower than a heat resistant temperature of said semiconductor chip, and heating said object to be bonded by said substrate heater while controlling the temperature of said substrate heater to a second temperature that is a predetermined temperature higher than the temperature of said chip heater and a softening point of said low melting point glass, in said sandwiched and compressed state, and thereafter cooling said low melting point glass constituting said bonding layer by lowering the temperature of said chip heater and the temperature of said substrate heater while maintaining said sandwiched and compressed state, and
a taking-out means for releasing said sandwiched and compressed state and taking out a bonded body constituted by said semiconductor chip glass-bonded to said object to be bonded, and
said object to be bonded has a thick part that is a part having a larger thickness than thicknesses of other parts, and
said substrate heater further comprises an auxiliary heating means configured so as to come into contact with a surface of said object to be bonded, which is neither said substrate surface to be bonded nor a substrate surface to be heated, which is a surface opposite to said substrate surface to be bonded among surfaces of said object to be bonded, in regard to said thick part.
